(19) United States
(12) Patent Application Publication
(10) Pub. No.: US 2009/0217030 A1
(43) Pub. Date: Aug. 27, 2009

(54) ADAPTIVE SERVER PERFORMANCE ADJUSTMENT

(76) Inventors: J. Premkumar, Tamil Nadu (IN); Allu Babula, Ganjam (IN)

Correspondence Address: SCHWEGMAN, LUNDBERG & WOESSNER/NOVELL, PO BOX 2938, MINNEAPOLIS, MN, 55402, US

(21) Appl. No.: 12/037,205

(22) Filed: Feb. 26, 2008

(51) Int. Cl. H04L 9/00

(52) U.S. Cl. 713/153

(57) ABSTRACT

Apparatus, systems, and methods may operate to calculate the cryptographic throughput for a gateway server, calculate the input-output throughput for the gateway server, and responsive to determining that the cryptographic throughput is less than the input-output throughput, add nodes to the gateway server cryptographic buffer queue when a projection indicates that the sum of data remaining in the cryptographic buffer queue and data available to enter the cryptographic buffer queue is greater than a preselected watermark value. Additional apparatus, systems, and methods are disclosed.

### BACKGROUND

A Virtual Private Network (VPN) is an extension of a private network that uses public network space (e.g., the Internet) to allow remote users or networks to connect to the private network. A VPN incorporates encryption and tunneling to deliver data safely and privately from the private network, across the public space, to a remote user/network.

The performance of gateway servers, operating at the junction of the private and public networks, is affected by many parameters. For example, data bottlenecks tend to form within secure sockets layer (SSL) VPN gateway servers when they are implemented using a proxy server and a cryptographic module.

Consider what happens when a new connection to an application server coupled to the private network is initiated by a client application coupled to the public network. A proxy client within the SSLVPN client makes a tunnel connection and sends its data to the SSLVPN client cryptographic module, where the client data is encrypted. The encrypted client data is then sent via the tunnel to the cryptographic module of the SSLVPN gateway server (coupled to the application server), where it is decrypted. The decrypted client data is then sent to the proxy server in the SSLVPN gateway, and thereafter to the application server after a new connection is established between the proxy server and the application server. When a reply in the form of application server data is received by the proxy server in the SSLVPN gateway server, the server data is sent by the proxy server to the gateway cryptographic module, where it is encrypted and sent on to the public network.

The server data is communicated within the SSLVPN gateway using transmission control protocol, internet protocol (TCP/IP) sockets. Thus, the rate at which the application server sends data to the proxy server will typically be greater than the rate at which the cryptographic module reads data from the proxy server because the data is both read and encrypted before sending it on to the client. Therefore, it is not uncommon for data bottlenecks to form within SSLVPN gateway servers.

### SUMMARY

In various embodiments, apparatus, systems, and methods for adaptive server performance adjustment operate to calculate the cryptographic throughput for a gateway server, calculate the input-output throughput for the gateway server, and responsive to determining that the cryptographic throughput is less than the input-output throughput, add at least one node to the cryptographic buffer queue.

Such activities may also include determining a time period to calculate a projection of filling a cryptographic buffer queue based on an incoming cryptographic module data rate, an outgoing cryptographic module data rate, and a cryptographic module encryption rate. Upon determining that the projection indicates the sum of data remaining in the cryptographic buffer queue and data available to enter the cryptographic buffer queue is greater than a preselected watermark value, nodes can be added to the cryptographic buffer queue, which can be managed as a circular linked list. Additional embodiments are described, and along with the foregoing example, will be set forth in detail below.

### BRIEF DESCRIPTION OF THE DRAWINGS

FIG. 1 is a flow diagram illustrating adaptive server performance adjustment methods using throughput comparison and projection value calculation to adjust the cryptographic buffer queue size, according to various embodiments of the invention.

FIG. 2 is a flow diagram illustrating adaptive server performance adjustment methods using data rate determination as part of adjusting the cryptographic buffer queue size, according to various embodiments of the invention.

FIG. 3 is a block diagram of adaptive server performance adjustment apparatus and systems, according to various embodiments of the invention.

### DETAILED DESCRIPTION

### Introduction

The challenges noted above, as well as others, may be addressed by adjusting cryptographic module buffer size within a gateway server based on calculated gateway throughput. In many embodiments, the parameters that affect throughput performance, including cryptographic module behavior, are tightly coupled to the buffer node allocation process.

Interprocess communication techniques often make use of the client-server model, referring to the two process that communicate with each other. The client process typically connects to the server process, making a request for information. While the client typically knows of the existence and address of the server prior to the connection being established, the server does not need to know the address of (or even about the existence of) the client. Once a connection is established, both sides can send and receive information.

Establishing a connection (including a VPN connection) between a client and a server in the network context often involves the basic construct of a socket. Each process, client and server, establish their own socket as one end of the interprocess communication channel.

The actions involved in establishing a socket on the client side may include creating a socket with a socket( )system call, and connecting the socket to the address of the server using the connect( )system call. Data may then be sent and received, perhaps using read( ) and write( ) system calls.

### Definitions

As used herein, an “application” refers to a set of software instructions, a service, or a system that interacts with data housed at a “data source,” which refers to a volume or collection of volumes that house the data for applications.

A “client terminal” means a hardware device that is capable or having one or more client processes executing on it.

“Cryptographic throughput” is a measure of how quickly the cryptographic module in a gateway server operates to encrypt data, decrypt data, or a combination of both (e.g., in bytes/second).

“Input-output throughput” is a measure of how quickly a gateway server operates to receive data, transmit data, or a combination of both (e.g., in bytes/second).

The terms “private network,” and “public network” are relative, which means that when something is designated as being in or forming part of a “private network,” this means it is not directly accessible by entities, such as clients, coupled to the public network. Similarly, when something is designated as being in or forming part of a “public network” (e.g., the Internet), this means that it does not normally have direct access to entities that are part of a private network. One useful mechanism for providing special access between the private network and the public network is a tunnel connection, such as that provided by a VPN.

### Fundamental Operations

In some embodiments, such as those that use a Novell® SSLVPN server, a cryptographic module that encrypts/decrypts data and a proxy module to serve as a proxy for incoming connections, are included. The cryptographic module communicates directly with an SSLVPN client using a TCP socket, and includes four buffers: a buffer ECBUF to receive encrypted data from the client, a buffer DCBUF to store decrypted client data before it is sent to the proxy module, a buffer DSBUF to store data received from the proxy module before sending to the client, and a buffer ESBUF to store encrypted proxy module data to be sent to the client.

Buffers sometimes act as bottleneck to the overall throughput of the gateway because of the difference in speeds at which networks and computers operate. On a dial-up connection, the network throughput will usually be lower than the throughput of the computer that is connected to it. On a gigabit network, throughput for the network will usually be higher than the throughput of the system that is connected to it. This latter situation commonly applies to SSLVPN gateways and other edge servers that are connected to a high speed internal network.

The optimal communication buffer size may depend on several factors. For example, some parameters that can influence the choice of buffer size include: the processing speed of the SSLVPN gateway, the throughput of the external (public) network, the throughput of the internal (private) network, the processing speed of the SSLVPN client, and the processing speed of the protected resource (e.g., application server).

In many embodiments, the algorithm used to adaptively adjust gateway server performance resides in an SSLVPN gateway. While it may be relatively simple to determine the processing speed of the gateway directly, the values of the other listed parameters may not be readily available. However, by observing the behavior of various gateway components, they may be determined in most cases. In addition, whenever a new SSLVPN tunnel is formed, the TCP socket buffer size for that tunnel can be selected based on the most recent throughput value obtained from the existing tunnels.

### Data Caching Mechanism

The cryptographic module in the gateway can be used to maintain a buffer queue implemented using a circular linked list of nodes. Each node may include a data buffer field, and a data length field (bound by the maximum size of the buffer).

Two variables, queue tot size and queue_current_size, which reflect the total number of nodes and number of nodes currently containing data, respectively, can also be maintained. These variables are used to indicate the current size of the queue at any moment without traversing the queue. The variable values are updated whenever a change is made to the size of the queue, or its content.

Since the cryptographic module function is typically processor-intensive, cryptographic operations can slow down module input/output (I/O) throughput due to filling the corresponding TCP socket buffer. To avoid this circumstance, the circular linked list maintained by the cryptographic module can be used to provide a dynamic and efficient memory management scheme. The circular linked list acts as a queue of buffers. The length of the queue (defined by the number of buffers) is determined by employing throughput calculation, as explained in the following section.

### Throughput Calculation

Throughput refers to measuring the amount of work done per unit time. Thus, in the SSLVPN context, throughput may be measured by the number of bits (or bytes) transferred across an SSLVPN gateway server per second. Prior approaches calculate throughput by dividing the number of bits/bytes transferred across an SSLVPN server by the total operational time for the server. This often does not provide a very accurate figure.

For the various embodiments described herein, throughput can be measured as the amount of work accomplished during the last (most recent) second of gateway cryptographic module operations. The Linux® gettimeofday( ) system call can be used for this function, providing millisecond granularity. Thus, the time taken for the following operations can be noted within the gateway server, so that throughput and other parameters can be calculated:
time taken to receive data from the public network (e.g., Internet)
time taken to decrypt data from the client
time taken to send decrypted data to the private network
time taken to receive data from the private network (e.g., from the application server)
time taken to encrypt the received private network data
time taken to send the encrypted private network data to the public network
   An update of this timing information can be performed, and calculations revised, once every second, or on any other convenient periodic basis.

After each timing update, the throughput rate for cryptographic functions and the throughput rate for I/O functions can be calculated. If the throughput rate for cryptographic functions is less than the throughput rate for I/O functions, additional buffers can be added to the queue when the projected values indicate possible buffer overflow.

For example, if Ir=the incoming data rate, Or=the outgoing data rate, and Er=cryptographic rate, the data remaining in the queue is Ir+(Or−Er). From these rates the time taken for the queue to completely fill (triggering data clogging and filling the TCP window) can be calculated. This value is also known as the “Projection.” If desired, the initial size of the queue can be determined based on the initial flow of data that triggers queue creation, since throughput calculations can begin prior to creation of the queue for a particular tunnel.

Therefore, the most general method of processing VPN tunnel data includes the activities of:
1. receiving data from the proxy client
2. comparing the calculated projection value with the preselected watermark level
3. adding a node to the queue if the queue contains data above the watermark level and the projection value indicates the possibility of filling the queue
4. reading data from the TCP buffer into the next free buffer in the queue
5. updating all throughput related variables related to reading data from the TCP buffer
6. empty the next node at the top of the queue (by transmitting data to the public network)
7. updating all throughput-related values corresponding to emptying the next node

### Methods

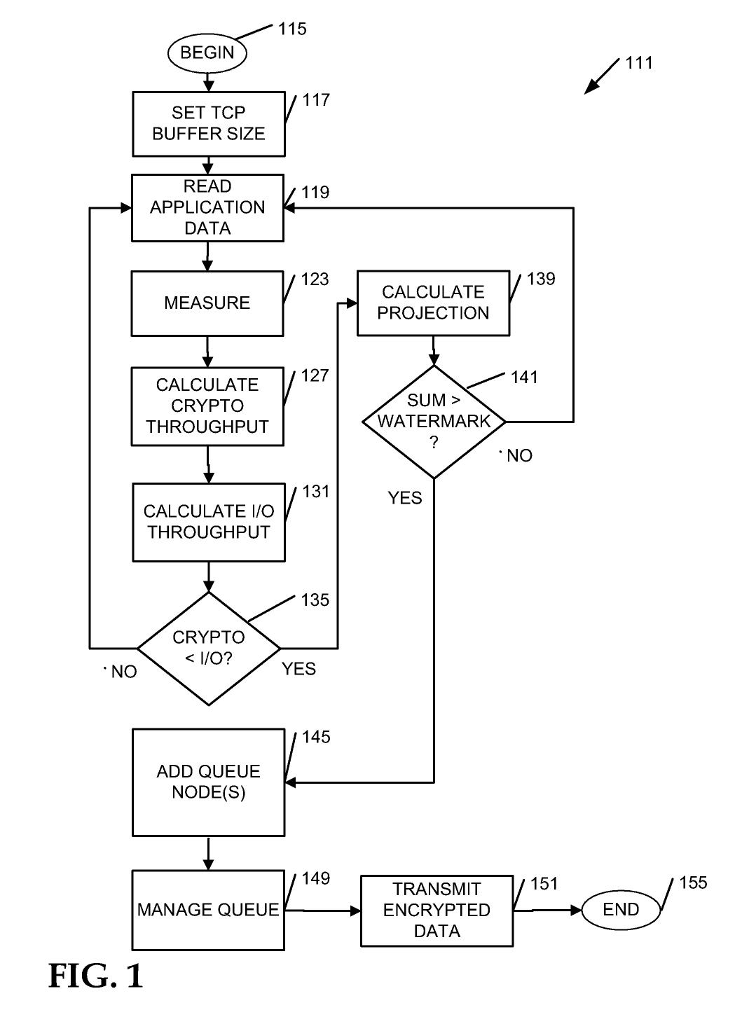

FIG. 1 is a flow diagram illustrating adaptive server performance adjustment methods 111 using throughput comparison and projection value calculation to adjust the cryptographic buffer queue size, according to various embodiments of the invention. The methods 111 are implemented in a machine-accessible and readable medium, and are operational over processes within and among networks. The networks may be wired, wireless, or a combination of wired and wireless. The methods 111 may be implemented as instructions, which when accessed by a machine, perform the processing depicted in FIG. 1. Given this context, adaptive server performance adjustment is now discussed with reference to FIG. 1.

In some embodiments, the method 111 of adaptive server performance adjustment may begin at block 115, and continue on to block 117 with setting a TCP buffer size associated with a gateway server and a tunnel (e.g., SSLVPN tunnel) based on a pre-existing tunnel throughput value. That is, before the tunnel connection is made between a client on the public network and the gateway server coupled to the private network, the TCP socket buffer size in the server cryptographic module that accepts data from the proxy subsystem/server module can be set; after the connection is made, the server buffer will be managed, as described below, to prevent filling the TCP socket buffer (so that a bottleneck that produces data clogging does not occur).

The method 111 may continue on to block 119 with reading application data from the TCP buffer into a free buffer in the cryptographic buffer queue, and then measuring cryptographic throughput associated with the application data at block 123. Measuring at block 123 may include periodically measuring one or more of the time taken to send and receive data with respect to the public network coupled to the gateway server, the time taken to encrypt and decrypt the data within the gateway server, and/or the time taken to send and receive the data with respect to the private network

The method 111 may include calculating a cryptographic throughput for the gateway server at block 127, and calculating the I/O throughput for the gateway server at block 131. Responsive to determining that the cryptographic throughput is less than the I/O throughput at block 135, the method 111 may include calculating a projection of filling the cryptographic buffer queue as a time period based on an incoming cryptographic module data rate, an outgoing cryptographic module data rate, and a cryptographic module encryption rate at block 139. As noted above, the projection to fill the cryptographic buffer queue=Ir (incoming crypto module rate)+(Or (outgoing crypto module rate)−Er (crypto module encryption rate)).

The method 111 may go on to include adding one or more nodes to the cryptographic buffer queue at block 145 upon determining that the projection indicates a sum of data remaining in the cryptographic buffer queue and data available to enter the cryptographic buffer queue is greater than a preselected watermark value at block 141. The cryptographic buffer queue may be managed as a circular linked list of buffers at block 149.

In some embodiments, the method 111 may include transmitting encrypted application data, wherein in the application data is received from an application server coupled to the gateway server at block 151. The method 111 may conclude at block 155

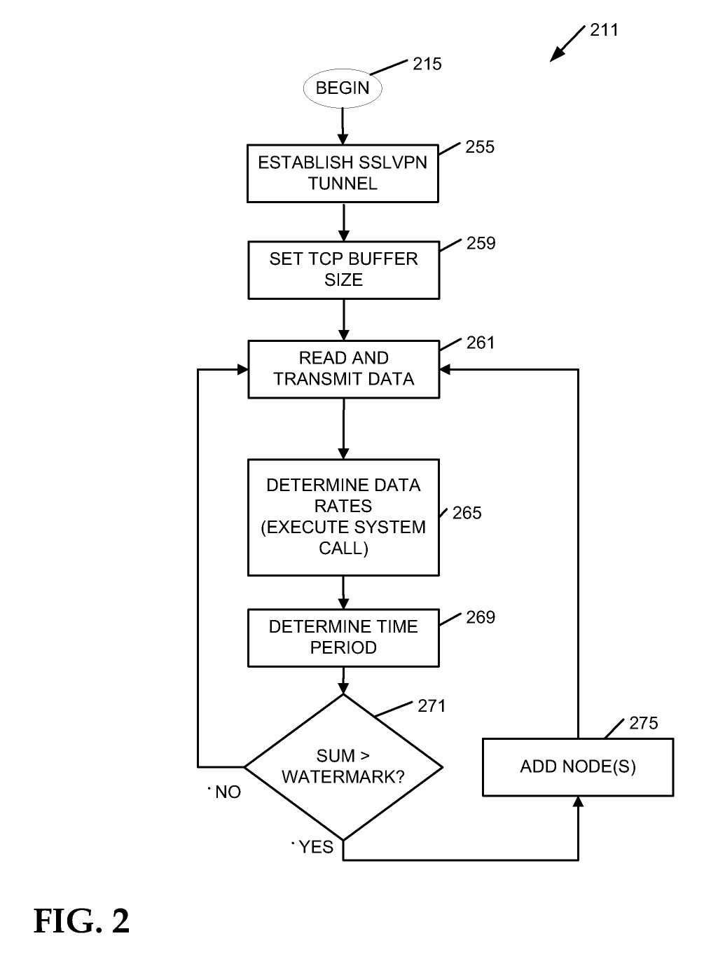

FIG. 2 is a flow diagram illustrating adaptive server performance adjustment methods 211 using data rate determination as part of adjusting the cryptographic buffer queue size, according to various embodiments of the invention. The methods 211 are implemented in a machine-accessible and readable medium, and are operational over processes within and among networks. The networks may be wired, wireless, or a combination of wired and wireless. The methods 211 may be implemented as instructions, which when accessed by a machine, perform the processing depicted in FIG. 2.

To implement adaptive server performance adjustment according to various embodiments of the invention, a method 211 may begin at block 215, and continue on to block 255 with establishing an SSLVPN connection 316 or tunnel within a public network (prior to determining the time period that is used to calculate the projection). The method 211 may continue on to block 259 with setting the TCP buffer size associated with the gateway server tunnel connection 316 based on a pre-existing tunnel connection throughput value.

The method 211 may go on to block 261 with periodically determining at least one of the incoming cryptographic module data rate, the outgoing cryptographic module data rate, or the cryptographic module encryption rate after reading application date from a TCP buffer into a free buffer of the cryptographic buffer queue, or after transmitting data to empty a buffer of the cryptographic buffer queue.

In many embodiments, the method 211 includes determining a variety of data rates. For example, the method 211 may include periodically determining the incoming cryptographic module data rate at block 265 by measuring the time taken to receive application data from a private network. The method 211 may also include periodically determining the outgoing cryptographic module data rate at block 265 by measuring the time taken to send encrypted data to a public network. The method 211 may also include periodically determining the cryptographic module encryption rate at block 265 by measuring time taken to encrypt application data. The method 211 may also include executing a system call (e.g., the Linux® gettimeofday ( ) system call) to obtain the current time to periodically determine at least one of the incoming cryptographic module data rate, the outgoing cryptographic module data rate, or the cryptographic module encryption rate.

The method 211 may go on to block 269 to include determining a time period based on the incoming cryptographic module data rate (e.g., Ir), the outgoing cryptographic module data rate (e.g., Or), and the cryptographic module encryption rate (e.g., Er) to calculate a projection of filling a cryptographic buffer queue. Upon determining that the projection indicates a sum of data remaining in the cryptographic buffer queue and data available to enter the cryptographic buffer queue is greater than a preselected watermark value at block 271, the method 211 may include adding one or more nodes to the cryptographic buffer queue at block 275. The cryptographic buffer queue can be managed as a circular linked list, and the time period to calculate the projection may be repeatedly determined at a rate of approximately once per second, or at any other convenient rate that is in accordance with the capabilities of the hardware and software employed in the SSLVPN communication system.

Those of ordinary skill in the art will realize that each of the method elements shown in FIG. 2 may be added to or substituted for any of the method elements shown in FIG. 1. Additionally, those of ordinary skill in the art will also realize that each of the method elements of both FIGS. 1 and 2 may be combined with the others in a variety of ways, to form a variety of methods that use the elements from each of the figures in serial, parallel, looped, and/or an otherwise repeated fashion. Thus, many other embodiments may be realized.

### Apparatus and Systems

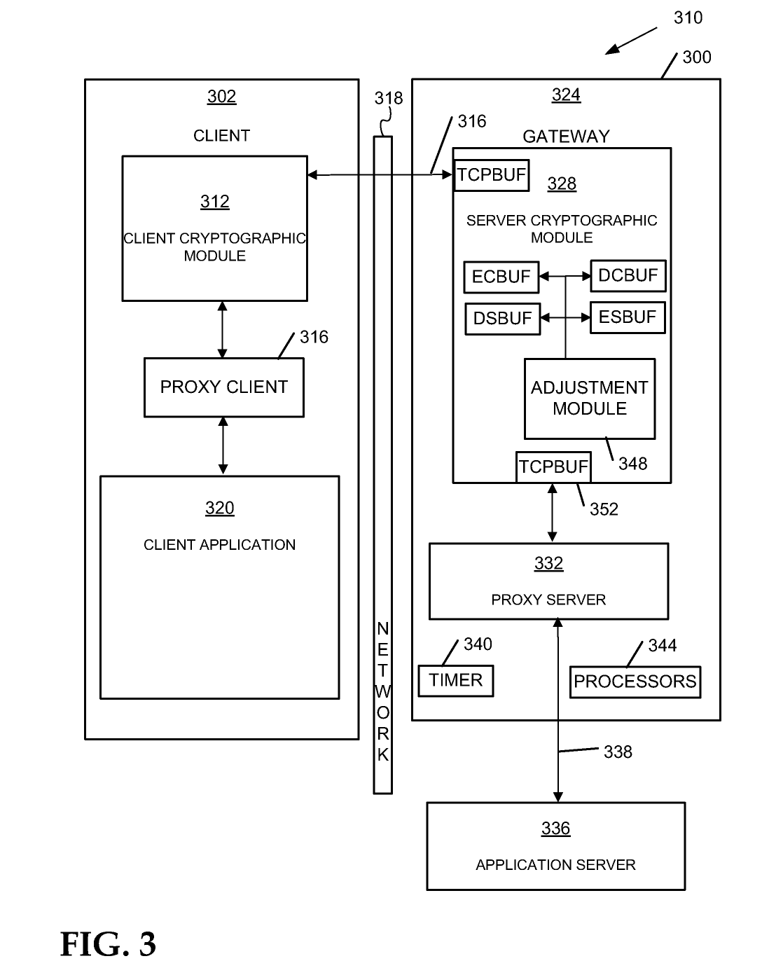

For example, FIG. 3 is a block diagram of adaptive server performance adjustment apparatus 300 and systems 310, according to various embodiments of the invention. The apparatus 300 and systems are implemented in a machine-accessible and readable medium and operational over one or more networks (e.g., the local area network (LAN) 338 and the wide area network (WAN) 318). The networks may be wired, wireless, or a combination of wired and wireless. The adaptive server performance adjustment apparatus 300 and systems 310 implement, among other things, the processing associated with the adaptive server performance adjustment methods 111 and 211 of FIGS. 1 and 2, respectively.

Turning now to FIG. 3, it can be seen that in some embodiments an adaptive server performance adjustment apparatus 300 comprises a gateway server 324 coupled to a public network 318 and a private network 338. A VPN tunnel 316, including an SSLVPN tunnel may be established between the gateway server 324 and an SSLVPN client 302, such as a client terminal.

The apparatus 300 may include one or more processors 344 configured to execute a variety of processes, and communicate with a server cryptographic module 328 to adaptively adjust the gateway server 324 performance after the VPN connection 316 is established. As shown here, the module 328 may comprise hardware, software, or firmware. Thus the module 328 may comprise a memory that includes instructions to execute any of the methods described herein. The processors 344 and memory within the module 328 may operate to form a portion of a symmetric multiprocessing architecture.

The apparatus 300 may comprise a server 324, a terminal, a personal computer, a workstation, or any combination of these. The module 328 and the processors 344 may be included in a single terminal or server 324, as shown, or exist as separate hardware elements, perhaps coupled together by a local area network (LAN) 338. Modules 312, 328, 348 may comprise hardware, software, and firmware, or any combination of these. Thus, many embodiments may be realized.

For example, an apparatus 300 may include a server 324 comprising a cryptographic module 328, a proxy subsystem 332 to couple to the cryptographic module 328 via a socket connection 352, and one or more processors 344 configured to execute a performance adjustment process 348 when a VPN connection 316 is established with the server 324. The cryptographic module 328 may comprise an encrypted client data reception buffer ECBUF, a decrypted client data reception buffer DCBUF, an application data reception buffer DSBUF, and an encrypted application data buffer ESBUF. Each of the buffers ECBUF, DCBUF, DSBUF, and ESBUF is implemented as a circular queue of memory buffers whose length (number of nodes) can be adjusted based on server throughput. TCP socket buffers TCPBUF may also be included in the gateway 324 as needed.

The performance adjustment process 348 may operate to calculate a cryptographic throughput and an I/O throughput for the server 324 and, responsive to determining that the cryptographic throughput is less than the I/O throughput, and that a sum based on a calculated buffer fill projection value will exceed a preselected watermark value, adding at least one node to a cryptographic buffer queue, including the queues maintained in one or more of buffers ECBUF, DSBUF. In another scenario, where data travels in the other direction, nodes can be added to the cryptographic buffer queue comprising the queues maintained in one or more of the buffers DCBUF, ESBUF.

Some embodiments of the apparatus 300 may include a server 324 comprising a timer 340 configured to measure a period of time which, upon expiration, triggers measuring at least one of time taken to send and receive data with respect to a public network coupled to the server, time taken to encrypt and decrypt the data, or time taken to send and receive the data with respect to a private network.

The server 324 may thus comprise a gateway server configured to accept an SSLVPN connection, and the processor(s) 344 may be used to execute a process (e.g., the module 348) to set a TCP buffer TCPBUF size for the tunnel 316 based on a pre-existing tunnel throughput value. The processor(s) 344 may be configured to maintain the cryptographic buffer queues in the form of a linked list of buffers (e.g., ECBUF, DCBUF, EDBUF, and ESBUF).

The client 302 may comprise a client cryptographic module 312, a proxy client 316, and a client application 320. The client 302 may comprise a single entity, or several entities in communication with one another, such as one or more Novell® Access Manager clients, or any device that can connect to a public network 318 using a VPN connection 316. Still further embodiments may be realized. For example, it can be seen that an adaptive server performance adjustment system 310 may comprise a client terminal 302 and any one or more components of the apparatus 300.

### Conclusion

Implementing the apparatus, systems, and methods described herein may thus provide improved performance for gateway servers coupled to SSLVPN connections. This approach strives to achieve a balance between static and dynamic buffer sizing by employing periodic throughput calculation to adjust the number of nodes in a cryptographic module buffer queue as needed. Socket buffer size can also be adjusted before a new connection is made.

Various embodiments of the invention can be implemented in existing network architectures, directory services, security systems, storage interfaces, operating systems, file system process, backup systems, replication systems, and/or communication devices. For example, in some embodiments, the techniques presented herein are implemented in whole or in part using Novell® network services, proxy server products, email products, operating system products, and/or directory services products distributed by Novell, Inc. of Provo, Utah.

Embodiments of the invention can therefore be implemented in a variety of architectural platforms, operating and server systems, devices, systems, or applications. Any particular architectural layout or implementation presented herein is thus provided for purposes of illustration and comprehension only, and is not intended to limit the various embodiments.

This Detailed Description is illustrative, and not restrictive. Many other embodiments will be apparent to those of ordinary skill in the art upon reviewing this disclosure. The scope of embodiments should therefore be determined with reference to the appended claims, along with the full scope of equivalents to which such claims are entitled.

The Abstract of the Disclosure is provided to comply with 37 C.F.R. §1.72(b) and will allow the reader to quickly ascertain the nature of the technical disclosure. It is submitted with the understanding that it will not be used to interpret or limit the scope or meaning of the claims.

In this Detailed Description of various embodiments, a number of features are grouped together in a single embodiment for the purpose of streamlining the disclosure. This method of disclosure is not to be interpreted as an implication that the claimed embodiments have more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. An apparatus, comprising:
a server comprising a cryptographic module;
a proxy subsystem to couple to the cryptographic module via a socket connection; and
a processor configured to execute a performance adjustment process when a VPN connection is established with the server, the performance adjustment process to calculate a cryptographic throughput and an input-output throughput for the server and, responsive to determining that the cryptographic throughput is less than the input-output throughput, adding at least one node to a cryptographic buffer queue when it is determined that a projection indicates a sum of data remaining in the cryptographic buffer queue and data available to enter the cryptographic buffer queue is greater than a preselected watermark value.

2. The apparatus of claim 1, wherein the server comprises:
a timer configured to measure a period of time which, upon expiration, triggers measuring at least one of time taken to send and receive data with respect to a public network coupled to the server, time taken to encrypt and decrypt the data, or time taken to send and receive the data with respect to a private network.

3. The apparatus of claim 1, wherein the cryptographic module comprises:
an encrypted client data reception buffer, a decrypted client data reception buffer, an application data reception buffer, and an encrypted application data buffer.

4. The apparatus of claim 1, wherein the server comprises a gateway server configured to accept a secure sockets layer (SSL) virtual private network (VPN) connection.

5. The apparatus of claim 1, wherein the processor is configured to maintain the cryptographic buffer queue in the form of a linked list of buffers.

6. A system, comprising:
a client terminal;
a server comprising a cryptographic module to couple to the client terminal using a secure sockets layer (SSL) virtual private network (VPN) tunnel, the server comprising a proxy subsystem to couple to the cryptographic module via a socket connection; and
a processor included in the server and configured to execute a performance adjustment process when a connection comprising the tunnel is established with the server, the performance adjustment process to calculate a cryptographic throughput and an input-output throughput for the server and, responsive to determining that the cryptographic throughput is less than the input-output throughput, adding at least one node to a cryptographic buffer queue when it is determined that a projection indicates a sum of data remaining in the cryptographic buffer queue and data available to enter the cryptographic buffer queue is greater than a preselected watermark value.

7. The system of claim 6, wherein the processor is to execute a process to set a transmission control protocol (TCP) buffer size for the tunnel based on a pre-existing tunnel throughput value.

8. The system of claim 6, wherein the processor forms a portion of a symmetric multiprocessing architecture.

9. A method, comprising:
calculating a cryptographic throughput for a gateway server;
calculating an input-output throughput for the gateway server; and
responsive to determining that the cryptographic throughput is less than the input-output throughput, adding at least one node to a cryptographic buffer queue when it is determined that a projection indicates a sum of data remaining in the cryptographic buffer queue and data available to enter the cryptographic buffer queue is greater than a preselected watermark value.

10. The method of claim 9, comprising:
managing the cryptographic buffer queue as a circular linked list of buffers.

11. The method of claim 9, comprising:
calculating the projection of filling the cryptographic buffer queue as a time period based on at least one of an incoming cryptographic module data rate, an outgoing cryptographic module data rate, or a cryptographic module encryption rate.

12. The method of claim 9, comprising:
adding the at least one node to at least one of a encrypted client data reception buffer, a decrypted client data reception buffer, an application data reception buffer, or an encrypted application data buffer.

13. The method of claim 9, comprising:
periodically measuring at least one of time taken to send and receive data with respect to a public network coupled to the gateway server, time taken to encrypt and decrypt the data, or time taken to send and receive the data with respect to a private network.

14. The method of claim 9, comprising:
reading application data from a transmission control protocol (TCP) buffer into a free buffer in the cryptographic buffer queue; and
measuring cryptographic throughput associated with the application data.

15. The method of claim 9, comprising:
transmitting encrypted application data, wherein in the application data is received from an application server coupled to the gateway server.

16. The method of claim 9, comprising:
setting a transmission control protocol (TCP) buffer size associated with the gateway server and the tunnel based on a pre-existing tunnel throughput value.

17. A method, comprising:
determining a time period based on an incoming cryptographic module data rate, an outgoing cryptographic module data rate, and a cryptographic module encryption rate to calculate a projection of filling a cryptographic buffer queue; and
adding a node to the cryptographic buffer queue managed as a circular linked list upon determining that the projection indicates a sum of data remaining in the cryptographic buffer queue and data available to enter the cryptographic buffer queue is greater than a preselected watermark value.

18. The method of claim 17, comprising:
periodically determining the incoming cryptographic module data rate by measuring time taken to receive application data from a private network.

19. The method of claim 17, comprising:
periodically determining the outgoing cryptographic module data rate by measuring time taken to send encrypted data to a public network.

20. The method of claim 17, comprising:
periodically determining the cryptographic module encryption rate by measuring time taken to encrypt application data.

21. The method of claim 17, comprising:
executing a system call to obtain the current time to periodically determine at least one of the incoming cryptographic module data rate, the outgoing cryptographic module data rate, or the cryptographic module encryption rate.

22. The method of claim 17, comprising:
periodically determining at least one of the incoming cryptographic module data rate, the outgoing cryptographic module data rate, or the cryptographic module encryption rate after reading application date from a transmission control protocol (TCP) buffer into a free buffer of the cryptographic buffer queue, or after transmitting data to empty a buffer of the cryptographic buffer queue.

23. The method of claim 17, comprising:
prior to determining the time period to calculate the projection, setting a transmission control protocol (TCP) buffer size associated with a gateway server tunnel connection based on a pre-existing tunnel connection throughput value.

24. The method of claim 17, comprising:
prior to determining the time period to calculate the projection, establishing a secure sockets layer (SSL) virtual private network (VPN) connection within a public network.

25. The method of claim 17, comprising:
repeating determining the time period to calculate the projection at approximately once per second.
